(19) United States
(12) Patent Application Publication
(10) Pub. No.: US 2006/0223627 A1
(43) Pub. Date: Oct. 5, 2006

(54) Gaming machine

(75) Inventors: Takashi Nozaki, Tokyo (JP); Youichi Terui, Tokyo (JP); Daijiro Tomoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/394,391

(22) Filed: Mar. 31, 2006

(30) Foreign Application Priority Data
Aug. 30, 2004 (JP) 2004-250831
Aug. 30, 2004 (JP) 2004-250840
Aug. 30, 2004 (JP) 2004-250876

(51) Int. Cl. A63F 13/00

(52) U.S. Cl. 463/20

(57) ABSTRACT

The present invention provides a gaming machine comprising: variable display means for variably displaying plural symbols in plural rows; internal winning combination determination means for determining an internal winning combination for each game; stop operation means which enables a player to perform a stop operation for stopping the variable display by the variable display means; and image display means for displaying an image, the gaming machine further comprising: input operation means for inputting game arcade-related information about a game arcade in which the gaming machine is installed; two-dimensional code conversion means for converting the game arcade-related information which has been input through the input operation means into a two-dimensional code; and display control means for displaying a two-dimensional code image indicating the two-dimensional code converted by the two-dimensional code conversion means on the image display means.

### CROSS-REFERENCE TO RELATED APPLICATIONS

This application relates to Japanese Patent Application Nos. 2004-250840, 2004-250831 and 2004-250876 filed on Aug. 30, 2004.

The contents of those applications are incorporated by reference herein in their entirety.

### BACKGROUND OF THE INVENTION

1. Field of the Invention

The present invention relates to a gaming machine such as a pachi-slot machine, a slot machine or a pachinko machine, which has a function of displaying a two-dimensional code.

2. Discussion of the Background

There have been conventionally known pachi-slot machines and slot machines as gaming machines including a variable display device with plural mechanical reels arranged for displaying plural symbols (for example, refer to Japanese Patent Laid-open Publication No. 2000-210413). Any of these machines are configured such that the respective reels are rotated for variably displaying the symbols and are stopped by player's operations using stop buttons (or automatically) in the pachi-slot machines or stopped after a certain time period in the slot machines, and gaming media such as medals and coins used in games (hereinafter, referred to as “coins”) are paid out if a combination of the symbols stopped and displayed along an effective line (hereinafter, the combination of the symbols will be referred to as a “symbol pattern”) becomes a specific combination.

There have been conventional pachi-slot machines configured to set a winning combination for playing a game without insertion of coins (hereinafter, such games will be referred to as “regaming” or “replaying”) and have a period when a probability that the internal winning combination for regaming is selected as an internal winning combination is set to be higher than usual (the period is also referred to as a “replaying time” or RT).

On the other hand, there have been some pachi-slot machines and slot machines including image display means for displaying images. For example, there have been pachi-slot machines including image display means for displaying representation images and the like, the image display means being disposed at the front of mechanical reels, or slot machines (so-called video slot machines) capable of displaying images which variably displays plural symbols as if mechanical reels were being rotated. Further, there have been gaming machines (video gaming machines) which include image display means for displaying an image (game image) indicating cards or mah-jongg tiles to permit to play image games using the game image. Further, there have been known gaming machines (also referred to as pachinko gaming machines or pachinko machines) which are configured to flow launched gaming balls downwardly along a gaming board and also include an image display device for displaying images using liquid crystals and the like.

The aforementioned conventional gaming machines including image display means have had problems as follows. Namely, gaming machines having the same game mode provide similar types of benefits while gaming machines having different game modes provide different types of benefits to players. For example, pachi-slot machines and slot machines pay out coins, video gaming machines increment points or the like, and pachinko gaming machines eject gaming balls, as the type of benefits provided to players. Gaming machines having the same game mode (for example, pachi-slot machines) are all configured to pay out coins as benefits, even though there are differences in content of representations or timing of provision of the benefits depending on the machine model. Consequently, gaming machines having the same game mode have had the problem of limit on the type of benefits.

The contents of Japanese Patent Laid-open Publication No. 2000-210413 are incorporated by reference herein in their entirety.

### SUMMARY OF THE INVENTION

The present invention has been made in light of the aforementioned problem and it is an object of the present invention to provide a gaming machine comprising image display means, such as a pachi-slot machine and a slot machine, the gaming machine allowing for diversification of benefits to players.

In order to solve the aforementioned problem, the present invention provides the following gaming machines.

According to a first aspect of the present invention, there is provided a gaming machine comprising: variable display means for variably displaying plural symbols in plural rows; internal winning combination determination means for determining an internal winning combination for each game; stop operation means which enables a player to perform a stop operation for stopping the variable display by the variable display means; and image display means for displaying an image, the gaming machine further comprising: determination means for determining whether or not a specific display condition is satisfied, the specific display condition being for determining whether or not a two-dimensional code should be displayed on the image display means; and display control means for displaying a two-dimensional code image indicating the two-dimensional code on the image display means if the determination means determines that the specific display condition is satisfied.

This gaming machine is configured such that the two-dimensional code image indicating the two-dimensional code is displayed on the image display means when a specific display condition is satisfied.

The aforementioned gaming machine can be configured such that the determination means determines whether or not the specific display condition is satisfied on the basis of whether or not symbols indicating a most profitable special increase combination are displayed on the variable display means.

The gaming machine is configured such that the two-dimensional code image indicating the two-dimensional code is displayed on the image display means when the symbols of the most profitable special increase combination are displayed on the variable display means.

According to the first aspect of the present invention, there is provided a gaming machine displaying a game image used in a game on image display means for displaying the game image to control a progress of an image game using the game image, the gaming machine further comprising: determination means for determining whether or not a specific display condition is satisfied, the specific display condition being for determining whether or not a two-dimensional code should be displayed on the image display means; and display control means for displaying a two-dimensional code image indicating the two-dimensional code on the image display means if the determination means determines that the specific display condition is satisfied.

This gaming machine is also configured such that the two-dimensional code image indicating the two-dimensional code is displayed on the image display means when a specific display condition is satisfied.

According to a second aspect of the present invention, there is provided a gaming machine comprising: variable display means for variably displaying plural symbols in plural rows; internal winning combination determination means for determining an internal winning combination for each game; stop operation means which enables a player to perform a stop operation for stopping the variable display by the variable display means; and image display means for displaying an image, the gaming machine further comprising: game history information storage means for storing game history information indicating a history of a game played by a player; readout means for reading out the game history information stored in the game history information storage means; two-dimensional code conversion means for converting the game history information read out by the readout means into a two-dimensional code; and display control means for displaying a two-dimensional code image indicating the two-dimensional code converted by the two-dimensional code conversion means on the image display means.

The gaming machine is configured such that the game history information indicating a history of a game played by a player is converted into the two-dimensional code and the two-dimensional code image indicating the two-dimensional code is displayed on the image display means.

According to the second aspect of the present invention, there is provided a gaming machine displaying a game image used in a game on image display means for displaying the game image to control a progress of an image game using the game image, the gaming machine further comprising: game history information storage means for storing game history information indicating the game history of games played by a player; readout means for reading out the game history information stored in the game history information storage means; two-dimensional code conversion means for converting the game history information read out by the readout means into a two-dimensional code; and display control means for displaying a two-dimensional code image indicating the two-dimensional code converted by the two-dimensional code conversion means on the image display means.

The gaming machine is also configured such that the game history information indicating a history of a game played by a player is converted into the two-dimensional code and the two-dimensional code image indicating the two-dimensional code is displayed on the image display means.

Preferably, any of the aforementioned gaming machines further comprises control means for controlling the two-dimensional code conversion means such that the two-dimensional code conversion means operates when a predetermined number of games have been played.

This configuration allows for reflection of contents of the predetermined number of games in the game history information.

According to a third aspect of the present invention, there is provided a gaming machine comprising: variable display means for variably displaying plural symbols in plural rows; internal winning combination determination means for determining an internal winning combination for each game; stop operation means which enables a player to perform a stop operation for stopping the variable display by the variable display means; and image display means for displaying an image, the gaming machine further comprising: input operation means for inputting game arcade-related information about a game arcade in which the gaming machine is installed; two-dimensional code conversion means for converting the game arcade-related information which has been input through the input operation means into a two-dimensional code; and display control means for displaying a two-dimensional code image indicating the two-dimensional code converted by the two-dimensional code conversion means on the image display means.

The gaming machine is configured such that game arcade-related information input by a clerk or the like of the game arcade is displayed as a two-dimensional code image on the image display means.

According to the third aspect of the present invention, there is provided a gaming machine displaying a game image used in a game on image display means for displaying the game image to control a progress of an image game using the game image, the gaming machine further comprising: input operation means for inputting game arcade-related information about a game arcade in which the gaming machine is installed; two-dimensional code conversion means for converting the game arcade-related information which has been input through the input operation means into a two-dimensional code; and display control means for displaying a two-dimensional code image indicating the two-dimensional code converted by the two-dimensional code conversion means on the image display means.

The gaming machine is also configured such that game arcade-related information input by a clerk or the like of the game arcade is displayed as a two-dimensional code image on the image display means.

As described above, the present invention can provide a gaming machine comprising image display means, such as a pachi-slot machine and a slot machine, the gaming machine allowing for diversification of benefits to players.

### BRIEF DESCRIPTION OF THE DRAWINGS

FIG. 1 is a perspective view illustrating the entire configuration of a pachi-slot machine as a gaming machine according to an embodiment of the present invention;

FIG. 2 is a view illustrating an image display portion;

FIG. 3 is a block diagram of the pachi-slot machine mainly illustrating the internal structure;

FIG. 4 is a block diagram mainly illustrating a sub control board;

FIG. 5 is a perspective view illustrating a configuration of reels including LED lamps placed inside the reels;

FIG. 6 is a perspective view illustrating the reel and a configuration placed inside the reel;

FIG. 7 is a perspective view schematically illustrating a configuration of a liquid crystal display device from the back side of a casing;

FIG. 8 is an exploded perspective view illustrating portion of the liquid crystal display device;

FIG. 9 is a front view illustrating a button unit;

FIG. 10 is a view illustrating one example of symbol rows drawn on the respective reel surfaces;

FIG. 11 is a flowchart illustrating operation procedures of main processing which is repeatedly executed after start of a game;

FIG. 12 is a flowchart illustrating procedures subsequent to those in FIG. 11;

FIG. 13 is a flowchart illustrating control procedures subsequent to the procedures in FIG. 12;

FIG. 14 is a flowchart illustrating control procedures subsequent to that in FIG. 13;

FIG. 15 is a view illustrating the image display portion when a two-dimensional code image is displayed, but not illustrating portion of the image display portion;

FIG. 16 is a flowchart illustrating procedures of a two-dimensional code display control processing;

FIG. 17 is a flowchart illustrating procedures of a sub control processing;

FIG. 18 is a flowchart illustrating procedures of another two-dimensional code display control processing;

FIG. 19 is a flowchart illustrating procedures of another sub control processing;

FIG. 20 is a flowchart illustrating a sub control processing different from those illustrated in FIG. 19;

FIG. 21 is a flowchart illustrating a sub control processing different from those illustrated in FIGS. 19, 20;

FIG. 22 is a flowchart illustrating procedures of a selection processing;

FIG. 23 is a flowchart illustrating procedures of a related-information input processing;

FIG. 24 is a flowchart illustrating procedures of an initial processing;

FIG. 25 is a view illustrating a system configuration of the entire game control system;

FIG. 26 is a flowchart illustrating a procedure of an intervention processing; and

FIG. 27 is a view illustrating a related-information input image.

### DESCRIPTION OF THE EMBODIMENTS

Hereinafter, first to third aspects of the present invention will be described. Unless otherwise specified, the term “the present invention” will include the first to third aspects of the present invention.

Hereinafter, embodiments of the present invention will be described. The same reference characters will indicate the same components, and redundant description will be omitted.

(Entire Configuration of Pachi-Slot Machine)

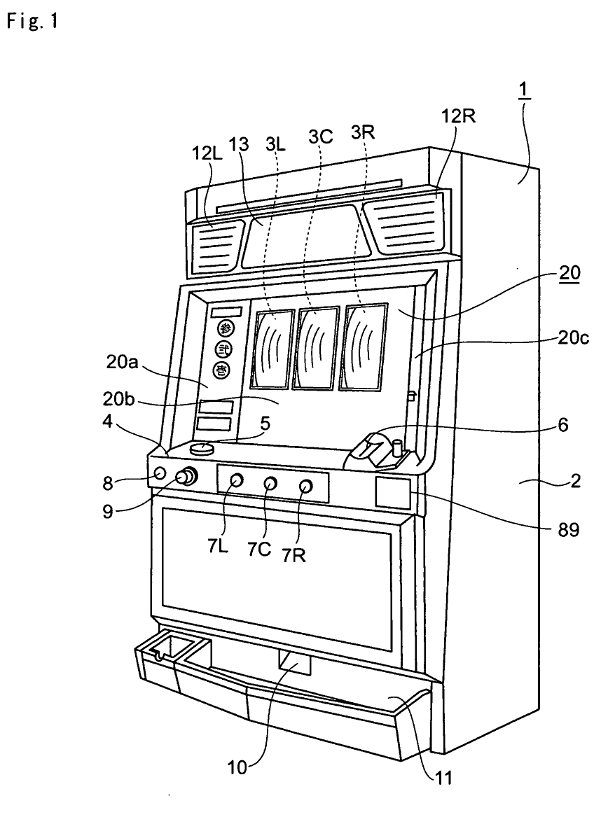

FIG. 1 is a perspective view illustrating the entire configuration of a pachi-slot machine 1. The pachi-slot machine 1 is a gaming machine according to an embodiment of the present invention and is configured to include variable display means for variably displaying plural symbols in plural rows and variably display the plural symbols with the variable display means and thereby provide a game.

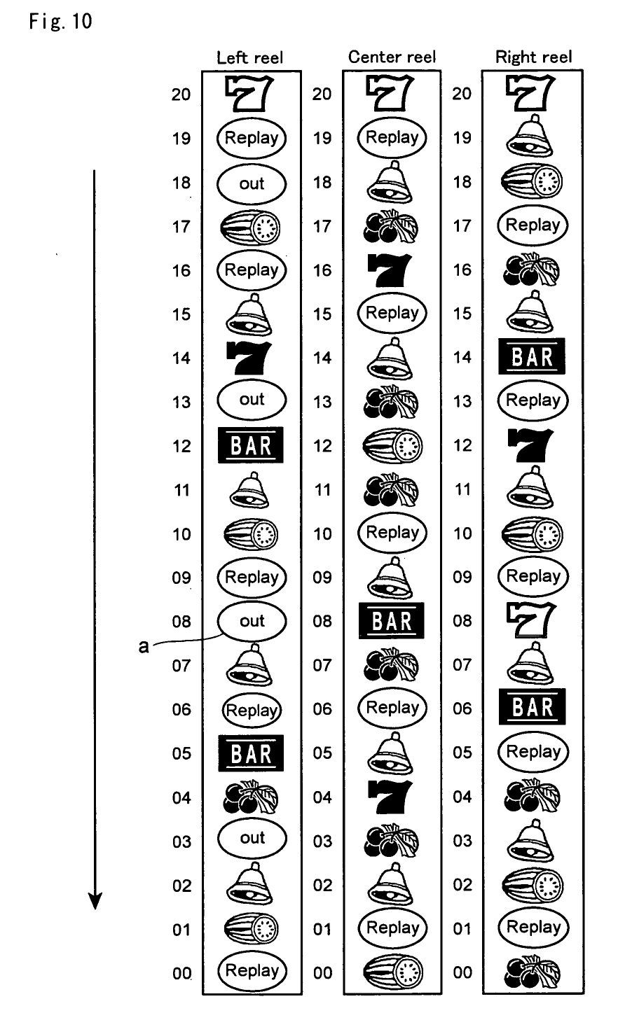

The pachi-slot machine 1 includes an image display portion 20 on the front side of a casing 2. Three mechanical reels 3L, 3C, 3R are rotatably arranged in a line abreast on the back side of the image display portion 20 within the casing 2. The reels 3L, 3C, 3R can be respectively viewed from the outside through symbol display regions 21L, 21C, 21R of the image display portion 20, which will be mentioned below. Each of the reels 3L, 3C, 3R is configured to rotate at a constant speed (for example, 80 rpm) and, as described below, has a symbol row including plural types of 21 symbols drawn on its outer peripheral surface (see FIG. 10). Thus, each of the reels 3L, 3C, 3R constitutes rotatable variable display means capable of variably displaying the symbols. Further, LED lamps (backlights) 29, not shown, are provided within the respective reels.

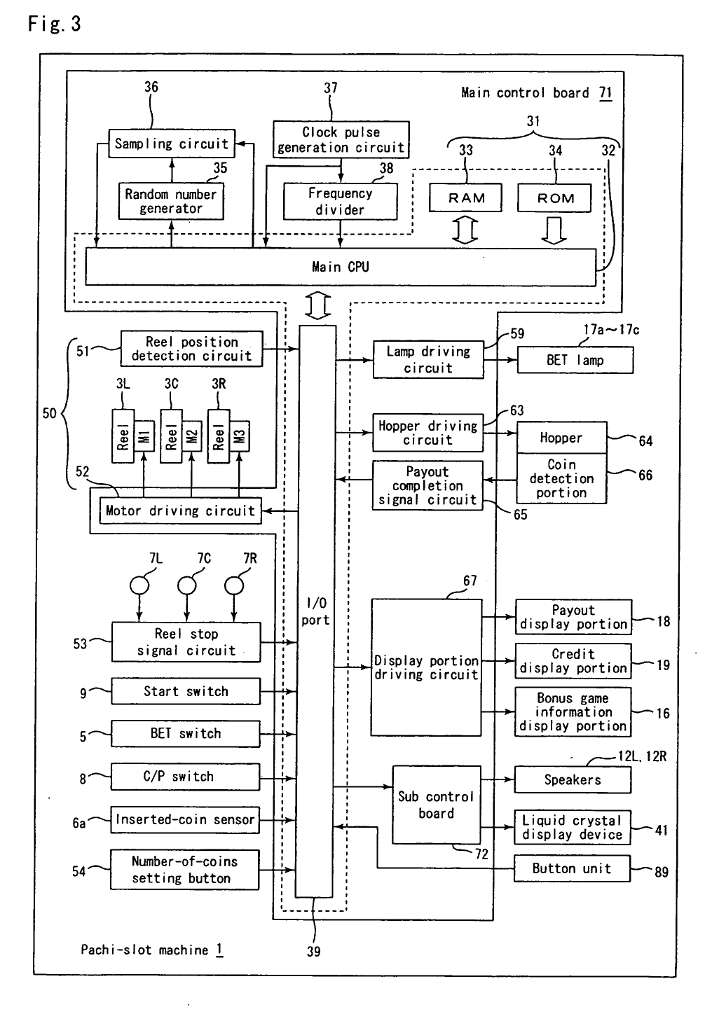

The pachi-slot machine 1 includes a substantially horizontal base portion 4 on the underside of the image display portion 20. The pachi-slot machine 1 also includes: a BET switch 5 on the left side of the base portion 4, the BET switch 5 being for setting of betting coins, which are credited, by push-button operation; and a coin slot 6 on the right side of the base portion 4, into which a player inserts coins. The coin slot 6 includes an inserted-coin sensor 6a (see FIG. 3) for outputting a signal indicating insertion of coins.

The pachi-slot machine 1 further includes, on the front side of the base portion 4, a C/P switch 8 for switching between credit and payout of coins, which the player has acquired in games, and a start switch 9, in this order from the left side. The pachi-slot machine 1 further includes, at the center on the front side of the base portion 4, three stop buttons 7L, 7C, 7R, and a button unit (input operation means according to the third aspect of the present invention) 89 on the right side. The start switch 9 is a switch which enables the player to rotate the respective reels 3L, 3C, 3R within the symbol display regions 21L, 21C, 21R and thereby to perform an operation for starting variable display of symbols (a game starting operation). The stop buttons 7L, 7C, 7R are provided as stop operation means which enables the player to stop the rotation (scroll display) of the reels 3L, 3C, 3R, respectively.

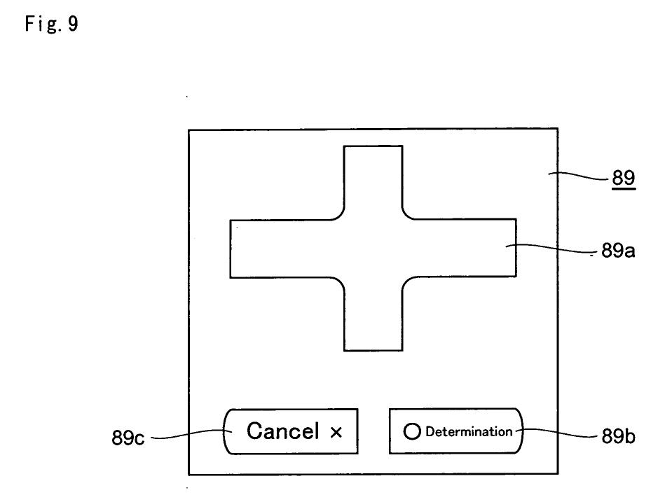

The button unit 89 includes a cross operation button 89a, a determination button 89b and a cancel button 89c, as illustrated in FIG. 9. The cross operation button 89a is an operation button which enables the player to perform desired input operations by moving a cursor upwardly, downwardly, leftwardly or rightwardly on a below-described liquid crystal display device 41 displaying a two-dimensional code selection image and a related-information input image. The determination button 89b is a button which enables the player to perform operations for selecting an item pointed out by the cursor. The cancel button 89c is a button which enables the player to perform operations for canceling the selection or determination of the item.

The pachi-slot machine 1 includes a coin payout opening 10 and a coin receiving portion 11 for storing paid-out coins, at the bottom of the casing 2. The pachi-slot machine 1 further includes speakers 12L, 12R at the left and right side above the image display portion 20 of the casing 2, respectively, and an allotment display panel 13 between the speakers 12L, 12R.

(Description of Image Display Portion)

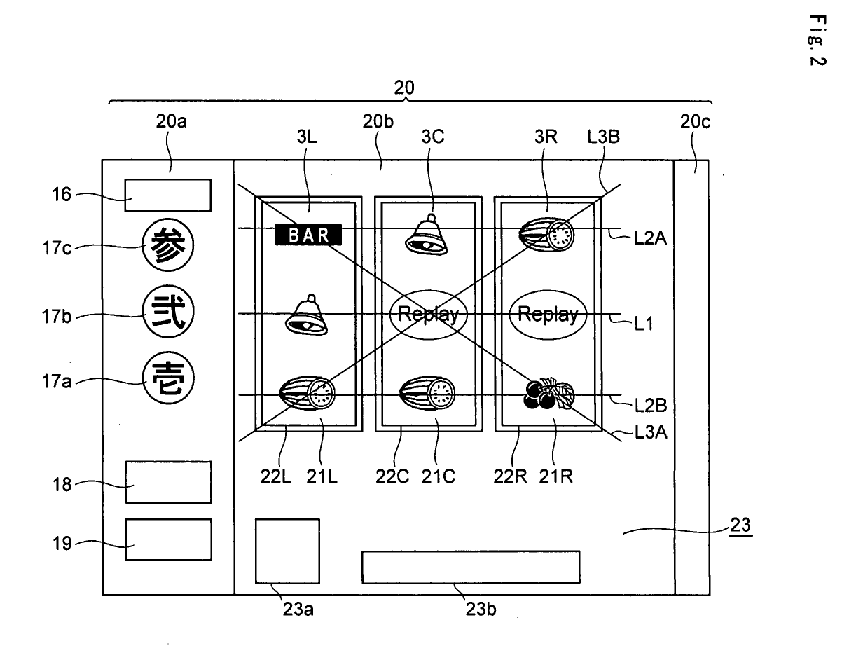

The image display portion 20 includes a panel display portion 20a, a liquid crystal display portion 20b and a fixed display portion 20c for displaying a predetermined image, as illustrated in FIG. 2.

The panel display portion 20a includes: a bonus game information display portion 16, BET lamps 17a, 17b, 17c, a payout display portion 18, and a credit display portion 19. The bonus game information display portion 16 displays game information during a bonus game. The BET lamps 17a, 17b, 17c are lighted depending on the number of coins betted on games. The payout display portion 18 indicates the number of coins to be paid out if a winning is satisfied. The credit display portion 19 displays the number of coins stored (credited).

The liquid crystal display portion (display means) 20b includes symbol display regions (display regions) 21L, 21C, 21R, window frame display regions 22L, 22C, 22R, and a representation display region 23. Display contents on the liquid crystal display portion 20b vary depending on variable display mode and stop mode of the reels 3L, 3C, 3R, and operational content of the liquid crystal display device 41.

The symbol display regions 21L, 21C, 21R are provided so as to correspond to the reels 3L, 3C, 3R, respectively. And the regions are provided to allow the player to view the symbols drawn on the respective reels 3L, 3C, 3R and thereby to provide various types of representations.

On the symbol display regions 21L, 21C, 21R, there are provided three horizontal winning lines (a center winning line L1, an upper winning line L2A and a lower winning line L2B) and two diagonal winning line (a left-upward diagonal line L3A and a right-upward diagonal line L3B), namely a total of five winning line. These winning lines are made effective in accordance with the number of inserted coins and an operation on the BET switch 5. The winning lines which are made effective are referred to as effective lines (also referred to as paylines). The BET lamps 17a to 17c are lighted to indicate the number of the effective lines. The symbol display regions 21L, 21C, 21R transparently display the symbols drawn on the reels 3L, 3C, 3R, respectively, so as to enable the player to view the symbols while not displaying representations using static images or moving images, when the reels 3L, 3C, 3R respectively corresponding to the regions are being rotated or when a stop operation can be performed using the stop buttons 7L, 7C, 7R respectively corresponding to the regions.

The window frame display regions 22L, 22C, 22R are provided to surround the corresponding symbol display regions 21L, 21C, 21R and operate as windows for displaying the symbols drawn on the respective reels 3L, 3C, 3R. The representation display region 23 is a region other than the symbol display regions 21L, 21C, 21R and the window frame display regions 22L, 22C, 22R on the liquid crystal display portion 20b. The representation display region 23 is configured to display representations for enhancing the player's interest in games and information required for advantageously progress of games by the player. Further, the representation display region 23 includes a two-dimensional code display portion 23a for displaying a two-dimensional code and a message display portion 23b for displaying a predetermined massage concerning the displayed two-dimensional codes, as illustrated in the figure.

(Configurations of LED Lamps and Reels)

The LED lamps 29 operates as illumination means for emitting light to the symbols drawn on the respective reels 3L, 3C, 3R from the back side of the symbols and also operates as illumination means for emitting light mainly to regions correspond to the symbol display regions 21L, 21C, 21 of a below-described liquid crystal display panel 44, from the back side of the symbols.

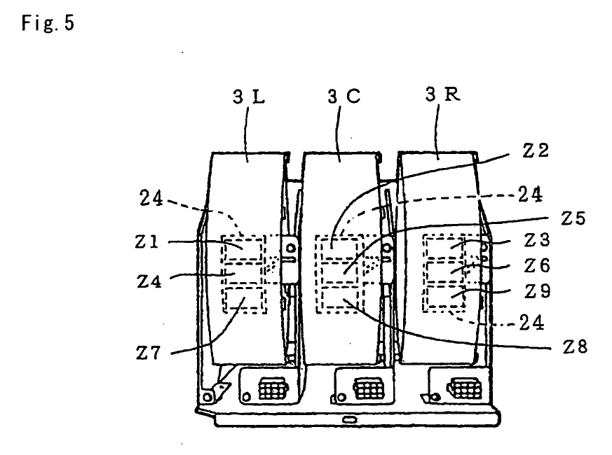

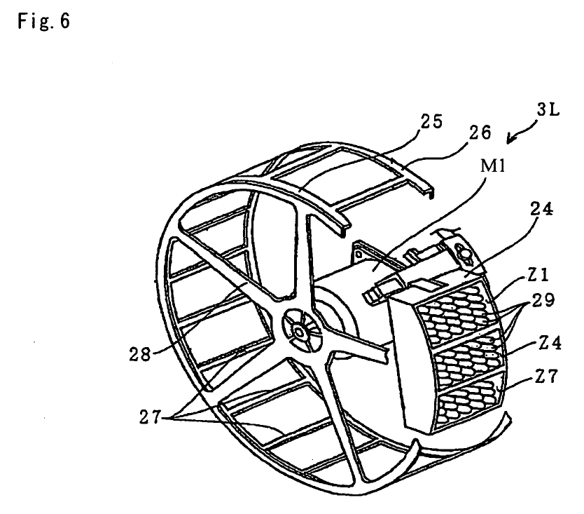

The LED lamps 29 are placed within the respective reels 3L, 3C, 3R, as illustrated in FIG. 5. There are installed circuit boards 24 for housing LEDs behind the symbols in three vertical rows (a total of 9 symbols), which appear within the symbol display regions 21L, 21C, 21R when the rotations of the reels 3L, 3C, 3R are stopped. The circuit boards 24 have three LED housing portions arranged along the rotation direction of the reels 3L, 3C, 3R. As illustrated in FIG. 6, the plural LED lamps 29 are arranged in the vertical and horizontal directions within the LED housing portions. In FIG. 5, there are illustrated the LED housing portions in the reels 3L, 3C, 3R which are arranged horizontally in three rows. The housing portions are shown as follows: the housing portions in the upper row are shown by Z1, Z2, Z3 from the left; the housing portions in the center row are shown by Z4, Z5, Z6 from the left; and the housing portions in the lower row are shown by Z7, Z8, Z9. The LED lamps 29 emit white light from the back side of translucent reel sheets (not shown), which are mounted on the respective reels 3L, 3C, 3R along the outer peripheral surfaces, and on which the symbols are drawn. The white light emitted from the LED lamps 29 is directed to the anterior side of the pachi-slot machine 1 through the reel sheets to illuminate the image display portion 20.

As illustrated in FIG. 6, the reel 3L includes a cylindrical frame constituted by two annular frames 25, 26 of the same shape, which are spaced apart with a predetermined distance therebetween, and plural coupling members 27 for coupling the annular frame 25 with the annular frame 26. The reel 3L includes a transfer member 28 for transferring a driving force from a stepping motor M1 (see FIG. 3) placed at the center of the cylindrical frame to the annular frames 25, 26. Between the annular frames 25, 26 are placed the aforementioned circuit board 24. The reels 3C, 3R have the same configuration as that of the reel 3L.

(Description of Liquid Crystal Display Device)

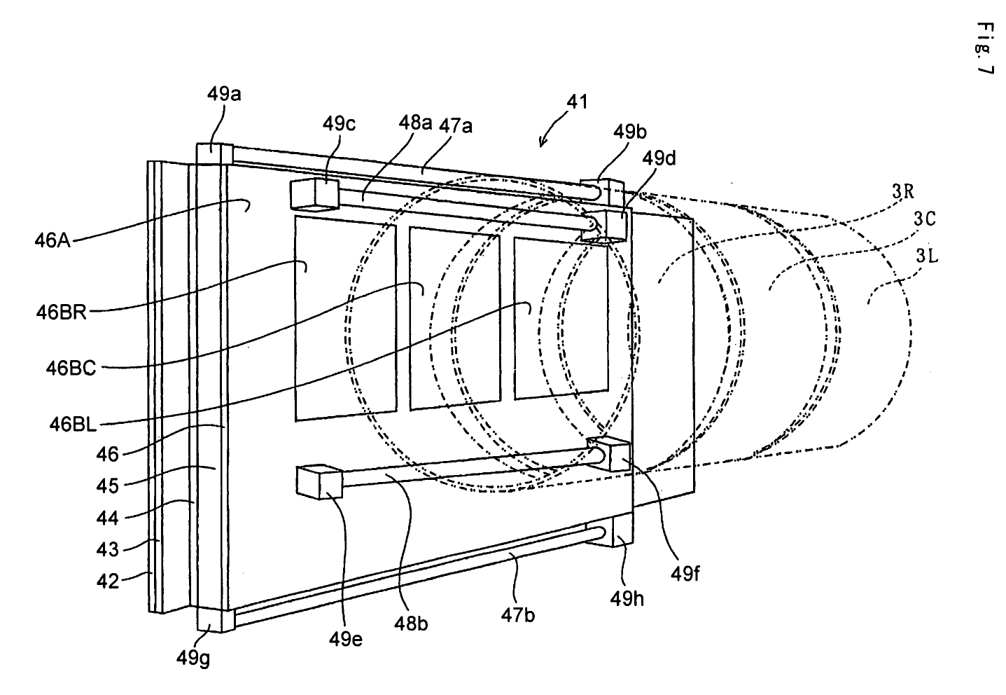

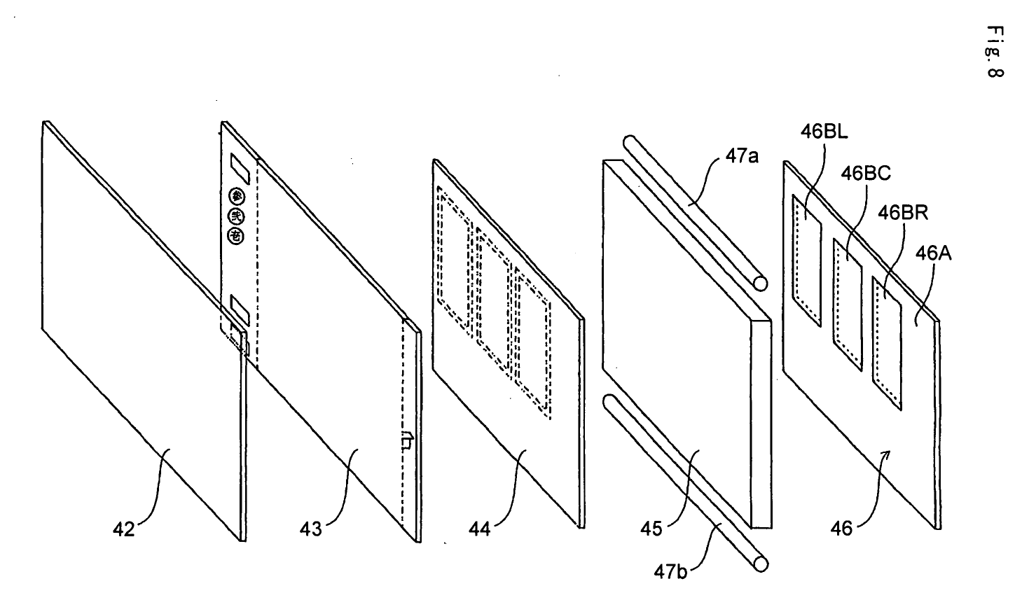

Next, the liquid crystal display device 41 will be described with reference to FIGS. 7, 8. FIG. 7 is a perspective view schematically illustrating a configuration of the liquid crystal display device 41 from the back side of the casing 2. FIG. 8 is an exploded perspective view illustrating portion of the liquid crystal display device 41.

The liquid crystal display device 41 is provided over the reels 3L, 3C, 3R and at the anterior side of the reels with a predetermined distance therebetween. And the liquid crystal display device 41 operates as image display means according to the present invention. The liquid crystal display device 41 includes a protective glass 42, a display plate 43, a liquid crystal display panel 44, a light guide plate 45, a reflection film 46, fluorescent lamps 47a, 47b, 48a, 48b as white light sources, lamp holders 39a to 39h and a flexible substrate (not shown) which is connected to a terminal portion of the liquid crystal display panel 44 and is constituted by a table carrier package (TCP) with ICs for driving the liquid crystal display panel 44.

The protective glass 42 and the display plate 43 have transparency. The protective glass 42 is provided for mainly protecting the liquid crystal display panel 44. In the display panel 43, images are drawn at regions corresponding to the panel display portion 20a and the fixed display portion 20c.

The liquid crystal display panel 44 is constituted by one transparent substrate such as a glass plate on which a thin-film transistor is formed, the other transparent substrate opposing thereto and liquid crystals filled between these transparent substrates. The liquid crystal display portion 20b is constituted by the symbol display regions 21L, 21C, 21R and the representation display region 23. The liquid crystal display panel 44 provides white display (light passes through the panel to the display surface and the light is viewable from the outside) when no voltage is applied on the liquid crystals (the liquid crystals are not driven). The liquid crystal display panel 44 is configured to be in a normally white mode, in which the reels 3L, 3C, 3R are viewable from the front side. By providing such a normally white mode liquid crystal display panel 44, a game can be played even if it becomes impossible to drive the liquid crystal filled in the panel 44, because the symbols drawn on the reels 3L, 3C, 3R can be viewed through the symbol display regions 21L, 21C, 21R, and therefore the symbols which are variably and statically displayed on the respective reels 3L, 3C, 3R can be viewed.

The light guide plate 45 has transparency and is placed on the back side of the liquid crystal display panel 44. The liquid guide plate 45 is provided for guiding light from the fluorescent lamps 47a, 47b into the liquid crystal display panel 44.

The reflection film 46 is provided for reflecting the light introduced into the light guide plate 45 to the surface side of the light guide plate 45. The reflection film 46 is made of a white polyester film or a vapor-deposited silver film formed on an aluminum thin film. The reflection film 46 has a reflection region 46A and non-reflection regions 46BL, 46BC, 46BR. The non-reflection regions 46BL, 46BC, 46BR are made of a transparent material and are formed as light transmitting portions for passing incident light therethrough without reflecting the incident light. The non-reflection regions 46BL, 46BC, 46BR are formed in correspondence with the symbol display regions 21L, 21C, 21R, respectively. Each of the non-reflection regions 46BL, 46BC, 46BR is placed in the front of three symbols which vertically appear in each of the reels when the rotation of the reels 3L, 3C, 3R is stopped. The reflection region 46A reflects incident light and operates as illumination means mainly for regions corresponding to the window frame display regions 22L, 22C, 22R and the representation display region 23 in the liquid crystal display panel 44.

The fluorescent lamps 47a, 47b are placed along the upper end and the lower end of the light guide plate 45, respectively. Both ends of the fluorescent lamp 47a, 47b are supported by the lamp holders 49a, 49b, 49g, 49h. The fluorescent lamps 47a, 47b generate light to be introduced to the light guide plate 45 and operate as illumination means mainly for regions corresponding to the window frame display regions 22L, 22C, 22R and the representation display region 23 in the region of liquid crystal display panel 44.

The fluorescent lamps 48a, 48b are placed at an upper position and a lower position behind the reflection film 46, respectively such that the lamps 48a, 48b are faced to the reels 3L, 3C, 3R. Namely, light emitted from the fluorescent lamps 48a, 48b is reflected by the surfaces of the reels 3L, 3C, 3R and then is made incident to the non-reflection regions 46BL, 46BC, 46BR to illuminate the liquid crystal display panel 44. Consequently, the fluorescent lamps 48a, 48b operate as illumination means for symbols formed on the respective reels 3L, 3C, 3R and also operate as illumination means for regions corresponding to the symbol display regions 21L, 21C, 21R in the reflection film 46.

FIG. 3 is a block diagram of the pachi-slot machine 1 mainly illustrating the internal structure. The pachi-slot machine 1 includes plural components as well as a main control board 71 including a microcomputer 31, the main control board serving as a main component. The main control board 71 includes the microcomputer 31, a random number generator 35, a sampling circuit 36, a clock pulse generation circuit 37 and a frequency divider 38. The pachi-slot machine 1 further includes a lamp driving circuit 59, a hopper driving circuit 63, a payout completion signal circuit 65 and a display portion driving circuit 67.

The microcomputer 31 includes a main CPU (Central Processing Unit) 32, a RAM (Random Access Memory) 33 and a ROM (Read Only Memory) 34. The main CPU 32 operates in accordance with programs stored in the ROM 34 to perform input and output of a signal to and from other components through an I/O port 39 and thereby to control the operation of the entire pachi-slot machine 1. The RAM 33 stores data and programs used in operation of the main CPU 32. For example, the RAM 33 temporarily stores a below-described random number value to be sampled by the sampling circuit 36 after start of the game and also stores code numbers and symbol numbers of the reels 3L, 3C, 3R. The ROM 34 stores programs to be executed by the main CPU 32 and permanent data.

The random number generator 35 operates according to commands from the main CPU 32 to generate random numbers within a certain range. The sampling circuit 36 extracts an arbitrary random number from the random numbers generated from the random number generator 35 and inputs the extracted random number to the main CPU 32, in accordance with commands from the main CPU 32. The clock pulse generation circuit 37 generates reference clocks for operating the main CPU 32. The frequency divider 38 input signals obtained by dividing the reference clocks at a constant period to the main CPU 32.

To the main control board 71 are further connected a reel driving unit 50 and a reel stop signal circuit 53. The reel driving unit 50 includes a reel position detecting circuit 51 for detecting each position of the reels 3L, 3C, 3R and a motor driving circuit 52 for inputting a driving signal to motors M1, M2, M3 for rotating the reels 3L, 3C, 3R. The motor driving circuit 52 inputs a driving signal to the motors M1, M2, M3 to operate the motors M1, M2, M3. Thereby, the motors M1, M2, M3 rotate the reels 3L, 3C, 3R, respectively. The reel stop signal circuits 53 outputs a stop signal according to stop operations on the respective stop buttons 7L, 7C, 7R and inputs the stop signal to the microcomputer 31 through the I/O port 39. Further, to the main control board 71 are connected a start switch 9, the BET switch 5, the C/P switch 8 and the inserted-coin sensor 6a so that they can input a signal to the main control board 71.

The lamp driving circuit 59 outputs a signal for lighting various types of lamps (the BET lamps 17a, 17b, 17c). The hopper driving circuit 63 drives a hopper 64 according to the control by the main CPU 32, and then the hopper 64 performs an operation for payout of coins to payout coins from the coin payout opening 10. The payout completion signal circuit 65 receives data of the number of coins from the coin detecting portion 66 connected to thereto, and then inputs a signal notifying the completion of payout of coins to the main CPU 32, when the number of coins reaches a set value. The coin detecting portion 66 counts the number of coins paid out from the hopper 64 and inputs data of the counted number of coins to the payout completion signal circuit 65. The display portion driving circuit 67 controls display operations of the respective display portions (the payout display portion 18, the credit display portion 19 and the bonus game information display portion 16).

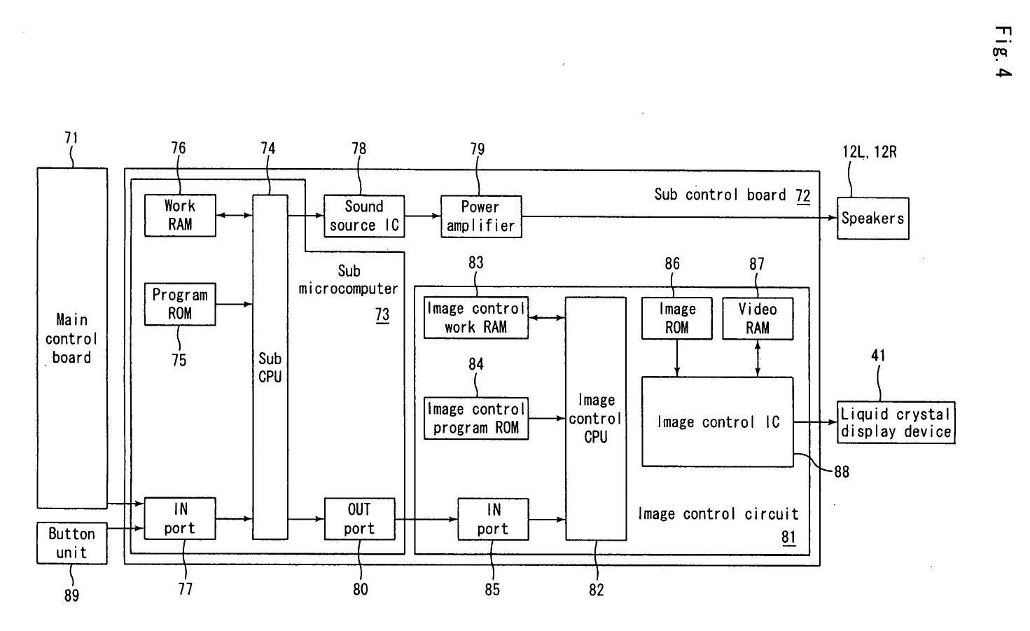

Further, a sub control board 72 is connected to the main control board 71. As illustrated in FIG. 4, the sub control board 72 receives a control command (command) from the main control board 71 and controls display on the liquid crystal display device 41 and output of sounds from the speakers 12L, 12R. The sub control board 72 is configured on a circuit board different from the circuit board which constitutes the main control board 71. The sub control board 72 has a microcomputer (hereinafter, referred to as “a sub microcomputer”) 73 as a main component, and further includes a sound source IC 78 for controlling sound to be output from the speakers 12L, 12R, a power amplifier 79 as an amplifier, and an image control circuit 81 which operates as display control means for the liquid crystal display device 41.

The sub microcomputer 73 includes a sub CPU 74 which performs a control operation in accordance with a control command transmitted from the main control board 71, a program ROM 75 as storage means, a work RAM 76 and I/O ports 77, 80. The sub control board 72 does not include a clock pulse generation circuit, a frequency divider, a random number generator and a sampling circuit, but it is configured to execute random number sampling in the operational programs of the sub CPU 74. The program ROM 75 stores control programs to be executed by the sub CPU 74. The work RAM 76 is configured as temporal storage means used when the aforementioned control programs are executed by the sub CPU 74. The work RAM 76 stores a game history information file (containing records of respective items of game history information) for managing game history information indicating a game history in the pachi-slot machine 1 (for example, the total number of played games, the number of games played during respective bonuses, the number of established bonuses, the probability of winning, players' private information).

The work RAM 76 operates as the game history information storage means according to the second aspect of the present invention.

The image control circuit 81 includes an image control CPU 82, an image control work RAM 83, an image control program ROM 84, an image ROM 86, a video RAM 87 and an image control IC 88. The image control CPU 82 determines an image to be displayed on the liquid crystal display device 41, in accordance with image control programs stored in the image control program ROM 84, on the basis of parameters set by the sub microcomputer 73.

The image control program ROM 84 stores image control programs and various types of selection tables relating to the display on the liquid crystal display device 41. In the pachi-slot machine 1, the image control program ROM 84 stores the game history information extracted by the sub CPU 74 and code conversion programs for converting below-described game arcade-related information input by an input operation on the button unit 89 into a two-dimensional code. The image control work RAM 83 is configured as temporal storage means used when the image control programs are executed by the image control CPU 82. The image control IC 88 creates an image (including two-dimensional code image) according to content determined by the image control CPU 82 and outputs the image to the liquid crystal display device 41.

The image ROM 86 stores dot data for creating an image. In the pachi-slot machine 1, plural types of dot data for displaying two-dimensional codes are stored. The video RAM 87 operates as temporal storage means used when an image is created by the image control IC 88.

(Description of Gaming States)

Next, there will be described gaming states in the pachi-slot machine 1 having the aforementioned configuration. The pachi-slot machine 1 has a “normal gaming state”, a “BB gaming state (Big-Bonus gaming state)” and a “RB gaming state (Regular-Bonus gaming state)” as gaming states.

The normal gaming state is a usual gaming state where no winning has been established. The BB gaming state is a special gaming state, to which the normal gaming state shifts when BB (the most profitable winning combination that enables the player to acquire the greatest benefit, and referred to as “special increase combination” or “big bonus”) is established as a starting condition (transition condition). During the BB gaming state, the player can play a below-described RB game or a normal game plural times. The player can play the RB game three times in a so-called A-type pachi-slot machine and once or twice in a so-called B-type pachi-slot machine. The player can play the normal game 30 times. When the gaming state shifts to the BB gaming state, the gaming state of the pachi-slot machine 1 becomes “BB normal gaming state”, and then becomes the “RB gaming state” when a predetermined condition is satisfied. The following description will be provided on the assumption that the pachi-slot machine 1 is of the A-type, but it also may be of the B-type.

The BB normal gaming state means a normal gaming state where BB is activated (during BB gaming state). In the BB normal gaming state, a probability that a so-called minor winning combination is selected as an internal winning combination is set to be higher than that in the normal gaming state, and thus winning of minor winning combination hits is generated with a higher probability.

The RB gaming state is a gaming state, to which the normal gaming state or the BB normal gaming state shifts when RB (a winning combination that is more profitable than normal games and enables the player to acquire a benefit different from the special increase combination, and referred to as “increase combination” or “regular bonus”) is established as a starting condition (transition condition). And the RB gaming state means a gaming state where the RB game is activated. During the RB game, the player can play a game (JAC game) plural times. In the game (JAC game), the player can establish a winning of a winning combination (referred to as “JAC”) and, if the winning combination is generated during the JAC game, coins are paid out with a higher allotment, and the player can acquire up to 112 coins. The RB gaming state ends when 12 games including RB games have been completed or a winning has been established 8 times.

The pachi-slot machine 1 according to the present embodiment has a specific gaming state in addition to the aforementioned gaming states. The specific gaming state can be generated without the establishment of winning of BB and RB. The specific gaming state is a gaming state which is different from the special gaming state and more profitable to the player than the normal gaming state. In the present embodiment, the specific gaming state is a gaming state where a probability of internal lottery (a probability that an internal winning combination is selected through internal lottery is referred to as “probability of internal lottery”) of a specific combination relating to a specific benefit to be provided the player in the gaming state is set to be higher than that in the normal gaming state. For example, the specific gaming state is a gaming state where a probability of internal lottery of an internal winning combination which generates replaying when a winning is established (hereinafter, the internal winning combination will be referred to as “replaying combination” and a symbol pattern thereof is “Replay-Replay-Replay” or “BAR-Replay-Replay”) is set to be higher than that in the normal gaming state during a replay time (RT) (in this case, the specific combination is the Replaying combination and the specific benefit is replay of the game). The specific gaming state also may be a concentration gaming state where a probability of internal lottery of a single bonus (also referred to as SB) is set to be higher than that in the normal gaming state, the single bonus allowing the player to play the JAC game one time. The specific gaming state also may be a gaming state where a probability of shift to the concentration gaming state is set to a predetermined value (concentration lottery gaming state). Also, the specific gaming state may be a gaming state during AT (Assist Time: a period when a type of an internal winning is notified) or a gaming state during CT (Challenge Time: a period when a control for drawing subsequent four symbols is not conducted for some of the reels).

(Operation Contents of Pachi-Slot Machine)

Next, there will be described control procedures of the main control board 71 and the sub control board 72, in operation contents of the pachi-slot machine 1.

(Operation Procedures of Main Control Processing)

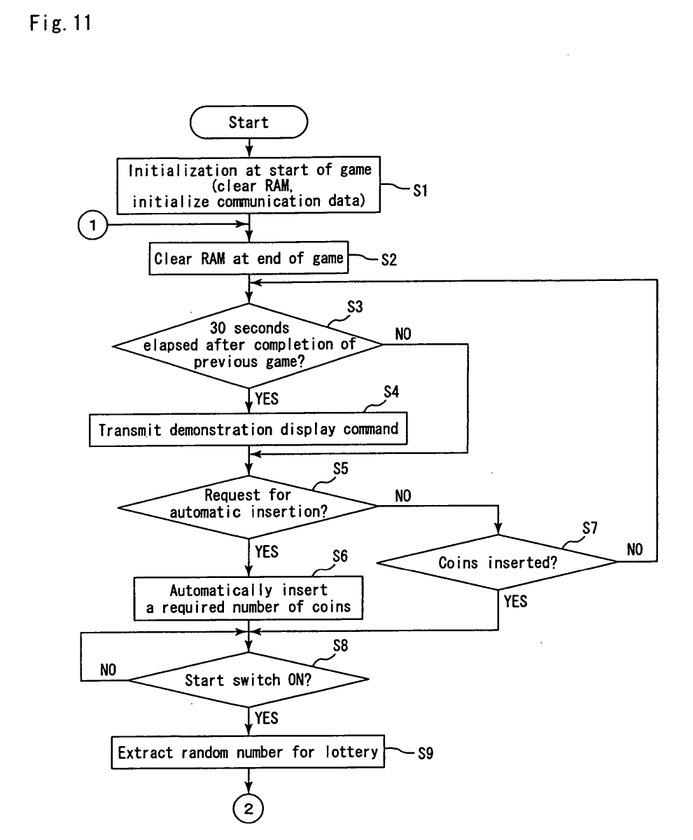

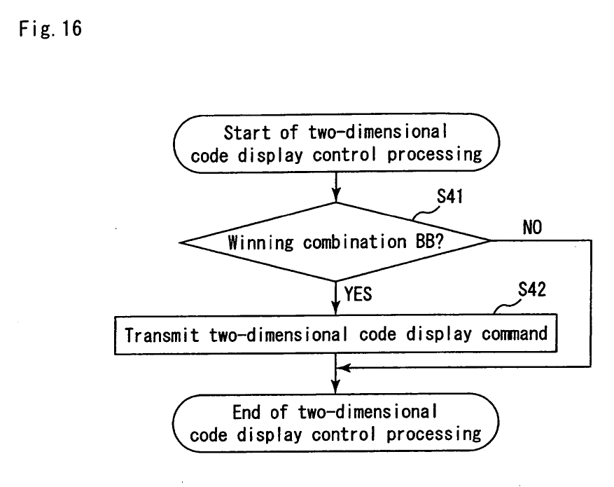

In the pachi-slot machine 1, an initial processing mentioned below, is executed at power-up. Subsequently, the pachi-slot machine 1 executes a main control processing under the control of the main CPU 32 in the main control board 71 according to flowcharts illustrated in FIGS. 11 to 14. FIGS. 11 to 14 are flowcharts (main flowcharts) illustrating operation procedures of the main control processing which is repeatedly executed after start of the game in the pachi-slot machine 1. In FIGS. 11 to 14, below-described FIG. 16 to FIG. 24 and FIG. 26, the term “step” is abbreviated to “S”.

In the pachi-slot machine 1, after starting the main processing, an initial processing (initialization of contents storage in the RAM 33, initialization of communication data and the like) at the start of the game is executed in step 1 as illustrated in FIG. 11. In subsequent step 2, the pachi-slot machine 1 executes clearing of data which was stored in the RAM 33 at the end of the game (erasure of data at a writable area of the RAM 33, the data being used during the previous game, writing of parameters required for the next game into the writable area of the RAM 33, designation of a start address for sequence program in the next game, and the like). Next, the processing proceeds to step 3 where it is determined whether or not 30 seconds has elapsed since the end of the previous game (since all the reels 3L, 3C, 3R were stopped). If 30 seconds has elapsed, the processing proceeds to step 4, and otherwise, the processing proceeds to step 5 without execution of step 4. In step 4, the main CPU 32 transmits a demonstration display command to the sub control board 72 and makes a request for display of a demonstration image to display the demonstration image on the liquid crystal display device 41.

In step 5, the main CPU 32 determines whether or not there is a coin automatic insertion request (namely, whether or not there was winning of replay (replay winning) in the previous game). If the main CPU 32 determines that there was replay winning, the processing proceeds to step 6 where a required number of coins are automatically inserted, and otherwise, the processing proceeds to step 7 where it is determined whether or not there is an input signal from the BET switch 5. If there is an input signal from the BET switch 5, a coin insertion command is set and then the processing proceeds to step 8, and otherwise, the processing returns to step 3.

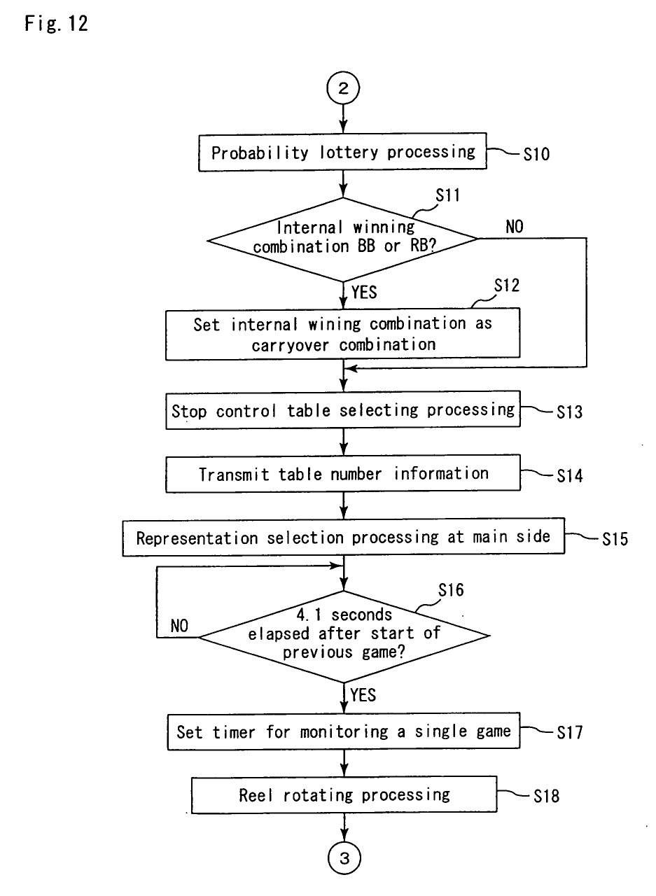

In step 8, the main CPU 32 waits input of a starting signal based on an operation on the start switch 9. If the starting signal is input, the main CPU 32 proceeds to step 9 where the main CPU 32 commands the sampling circuit 36 to extract a random number for lottery, which are used in a below-described probability lottery processing. Thereafter, a flag (gaming state flag) is set in accordance with the gaming state set in the previous game and then the processing proceeds to step 10 illustrated in FIG. 12 where a probability lottery processing is executed.

In the probability lottery processing in step 10, the main CPU 32 sets the extracted random number value as a search key to search an area corresponding to the gaming state flag in a probability lottery table (not shown) into which random numbers and internal lottery probabilities for the respective gaming states are stored in association with each other. Then the main CPU 32 selects an internal winning combination corresponding to the extracted random number value and then ends the probability lottery processing.

Next, in step 11, it is determined if the internal winning combination selected in the probability lottery processing in step 10 is BB or RB. If the internal winning combination is BB or RB, the processing proceeds to step 12, and otherwise, the processing proceeds to step 13 without execution of step 12. In step 12, BB or RB out of the internal winning combinations determined in step 10 is set as a carryover winning combination. In step 13, the main CPU 32 operates as internal winning combination determination means and determines an internal winning combination on the basis of the result of the probability lottery processing. Then, the main CPU 32 selects a stop control table (for establishing winning or for not-establishing winning), into which stop operation positions and stop control positions for the reels 3L, 3C, 3R are stored in association with each other, on the basis of the determined internal winning combination, the gaming state and the like. In subsequent step 14, table number information indicating the selected stop control table is transmitted to the sub control board 72. Then, in step 15, a representation selection processing at the main side is executed to determine items relating to representations of games on the liquid crystal display device 41.

Then, the processing proceeds to step 16 where it is determined whether or not 4.1 seconds has elapsed since the start of the previous game. If 4.1 seconds has elapsed, the processing proceeds to step 17, and otherwise, the processing returns to step 16 and the main CPU 32 waits until 4.1 seconds (waiting time) has elapsed since the start of the previous game. In the present embodiment, the waiting time is set to 4.1 seconds, but the waiting time may be varied depending on the gaming mode (for example, 5 seconds for the type A, 4.1 seconds for the type B and the like).

Next, the processing proceeds to step 17 where a timer for monitoring a single game (a timer for measuring the waiting time) is set. Then, the processing proceeds to step 18. The main CPU 32 transmits, to the motor driving circuit 52, a driving signal output command indicating a request for the start of rotation of all the reels 3L, 3C, 3R to execute a reel rotating processing for rotating the reels 3L, 3C, 3R. The main CPI 32 also sets a reel stop permission command.

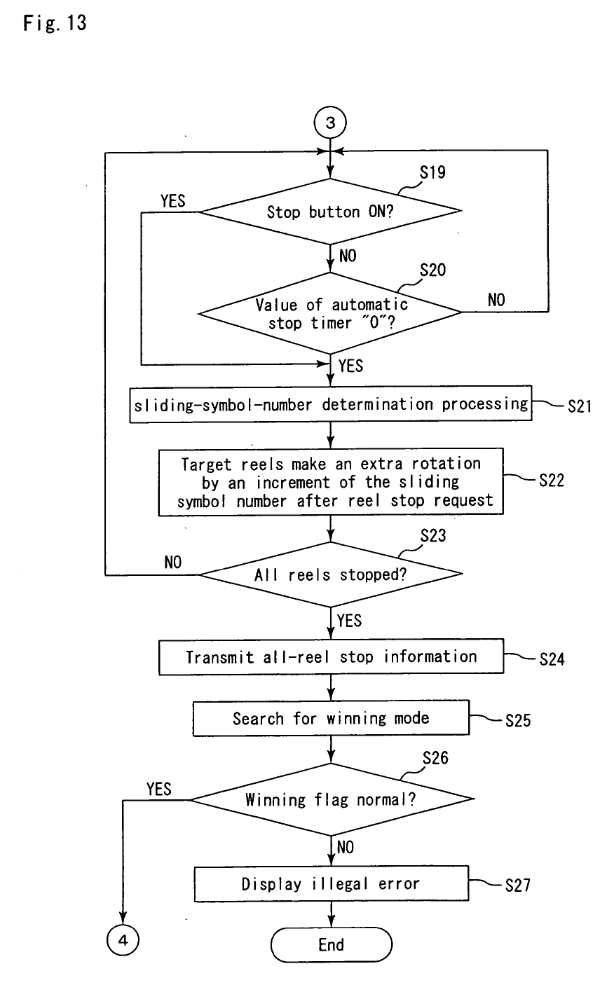

Then, the processing proceeds to step 19 illustrated in FIG. 13 where the main CPU 32 determines whether or not the stop buttons 7L, 7C, 7R are ON (whether or not the stop buttons 7L, 7C, 7R have been operated), based on input signals from the reel stop signal circuit 53. If the stop buttons are ON, the processing proceeds to step 21, and otherwise, the processing proceeds to step 20 where it is determined whether or not a value of an automatic stop timer is “0”. If the value is “0”, the processing proceeds to step 21, and otherwise, the processing returns to step 19. In step 21, the main CPU 32 executes a sliding-symbol-number determination processing to determine the sliding symbol number within a predetermined range of the maximum sliding symbol number (for example, four symbols), on the basis of the internal winning combination, the gaming state, the order of stopping, the stop operation position and the like. Thereafter, the processing proceeds to step 22 where target reels make an extra rotation by an increment of the sliding symbol number determined in the sliding-symbol-number determination processing, after a reel stop is requested.

Further, the processing proceeds to step 23 where the main CPU 32 determines whether or not all the reels 3L, 3C, 3R have been stopped. If all the reels 3L, 3C, 3R have been stopped (all-reel stop), the processing proceeds to step 24, and otherwise, the processing returns to step 19. In subsequent step 24, the main CPU 32 transmits all-reel stop information indicating that all the reels have been stopped, to the sub control board 72.

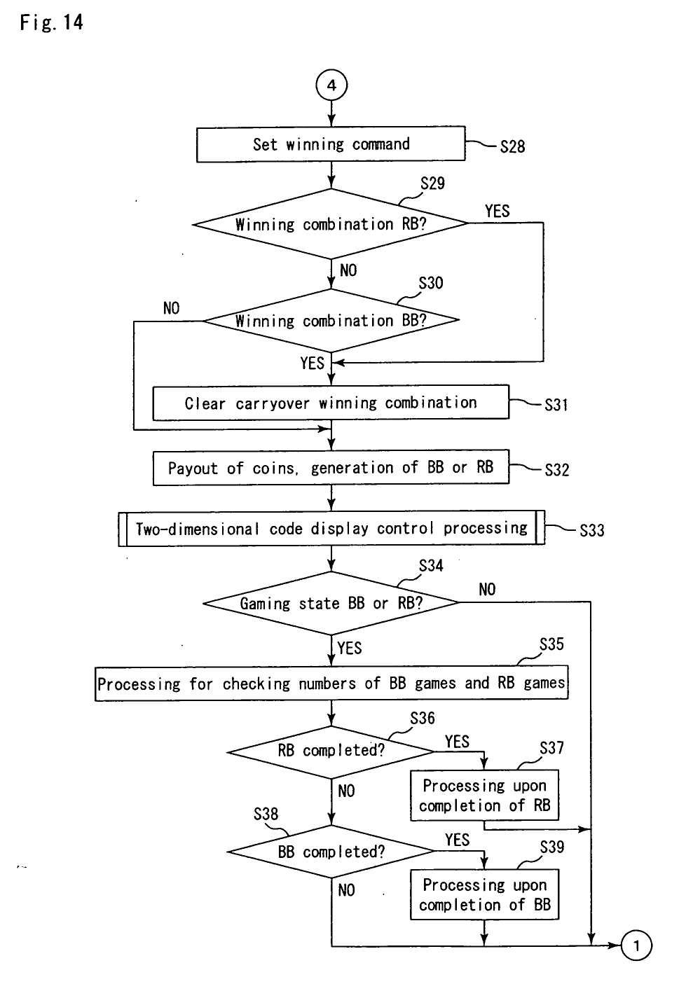

Then, the processing proceeds to step 25 where the main CPU 32 searches for a winning mode and sets a winning flag for identifying a winning combination shown by the symbols on the reels 3L, 3C, 3R which have been stopped, if a winning is established. If no winning is established, a winning flag is not set and the processing returns to step 2, although the procedures in such a case are not illustrated. Then, the processing proceeds to step 26 where it is determined whether or not the winning flag is normal. If it is not normal, then the processing proceeds to step 27 where an illegal error is indicated and the processing ends to intervene in the game. If it is normal, the processing proceeds to step 28 illustrated in FIG. 14 where a winning command is transmitted to the sub control board 72 and then the processing proceeds to step 29.

In step 29, it is determined whether or not the winning combination is RB. If it is RB, the processing proceeds to step 31. If it is not RB, the processing proceeds to step 30 where it is determined whether or not the winning combination is BB. If it is determined that the winning combination is BB, the processing proceeds to step 31, and otherwise, the processing proceeds to step 32.

In step 31, the carryover winning combination is cleared and then the processing proceeds to step 32. In step 33, coins of the number corresponding to the symbol pattern statically displayed along effective lines are paid out and the gaming state is shifted to BB or RB. In subsequent step 32, a two-dimensional code display control processing according to the present invention is executed in accordance with the flowchart illustrated in FIG. 16.

After starting the two-dimensional code display control processing, the main CPU 32 proceeds to step 41 illustrated in FIG. 16. The main CPU 32 operates as determination means to determine whether or not a specific display condition is satisfied, the specific display condition being for determining whether or not a two-dimensional code should be displayed on the liquid crystal display device 41. At this time, whether or not the specific display condition is satisfied is determined on the basis of whether or not the winning combination is BB. If the specific display condition is satisfied, namely the winning combination is BB (in this case, a symbol pattern indicating BB is displayed), the processing proceeds to step 42 where a two-dimensional code display command is transmitted to the sub control board 72 and then the two-dimensional code display control processing ends. If the winning combination is not BB, the two-dimensional code display control processing ends without execution of step 42.

In FIG. 14, the processing proceeds to step 34 where it is determined whether or not the gaming state is BB or RB. If the gaming state is BB or RB, the processing proceeds to step 35, and otherwise, the processing returns to step 2. In step 35, a processing for checking the number of BB games or RB games is executed to check the number of times the RB gaming state has been generated, the number of games during the BB normal gaming state, the number of times winning has been established during the RB gaming state, the number of games during the RB gaming state. Then, the processing proceeds to step 36 where it is determined whether or not the RB gaming state has completed on the basis of the result of step 35. If the RB gaming state has completed, the processing proceeds to step 37, and otherwise, the processing proceeds to step 38.

In step 37, information stored in a predetermined region of the RAM 33 is cleared, then a processing for completing the RB gaming state is executed and then the processing returns to step 2. In step 38, it is determined whether or not the BB gaming state has completed, on the basis of the result of step 35. If the BB gaming state has completed, the processing proceeds to step 39, and otherwise, the processing returns to step 2. In step 39, information stored in a predetermined region of the RAM 33 is cleared, then a processing for completing the BB gaming state is executed and then the processing returns to step 2.

(Operation Procedures of Initial Processing)

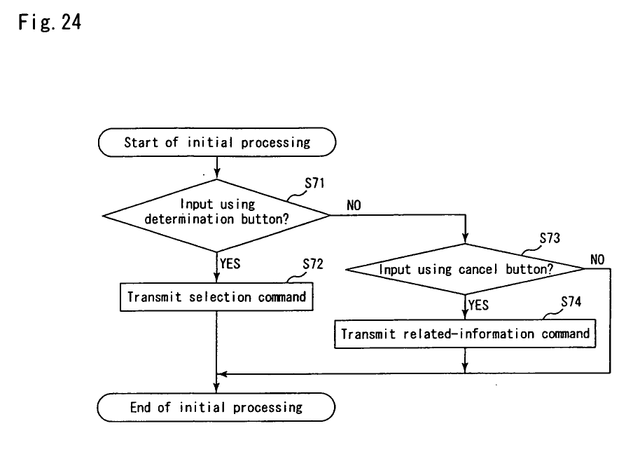

In the pachi-slot machine 1, an initial processing is executed at power-up, according to a flowchart illustrated in FIG. 24. In this initial processing, the main CPU 32 proceeds to step 71 where the main CPU 32 determines whether or not an operator has performed input using the determination button 89b (touched the determination button 89b) after the power-up. If the operator has performed input using the determination button 89b, the processing proceeds to step 72 where the main CPU 32 transmits a selection command to the sub control board 72, and otherwise, the processing proceeds to step 73 where it determines whether or not the operator has performed input using the cancel button 89a (touched on the cancel button 89a). If the operator has performed input using the cancel button 89a, the processing proceeds to step 74 where a related-information input command is transmitted to the sub control board 72, and otherwise, the initial processing ends. FIG. 24 illustrates only the steps relating to the present invention in the initial processing executed at power-up while not illustrating other steps. Steps 71, 72 correspond to a modified example 2 which will be described below. Steps 73, 74 correspond to a modified example 3 which will be described below.

(Operation Procedures of Sub Control Processing)

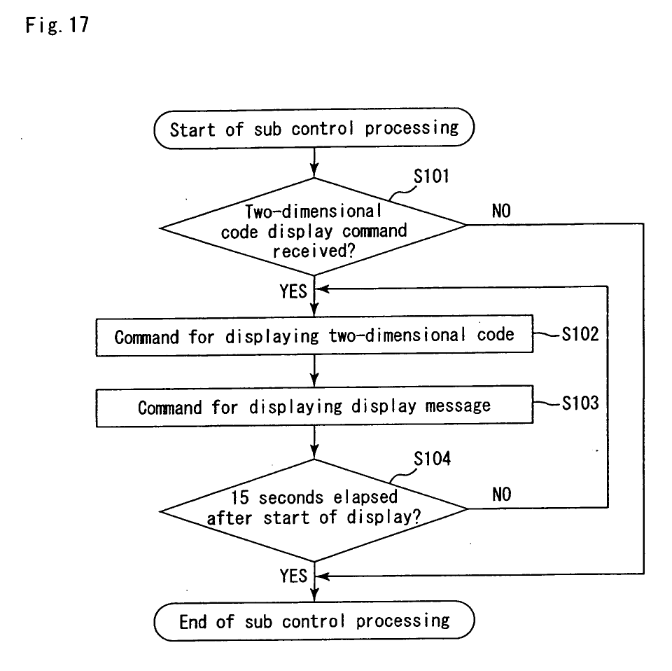

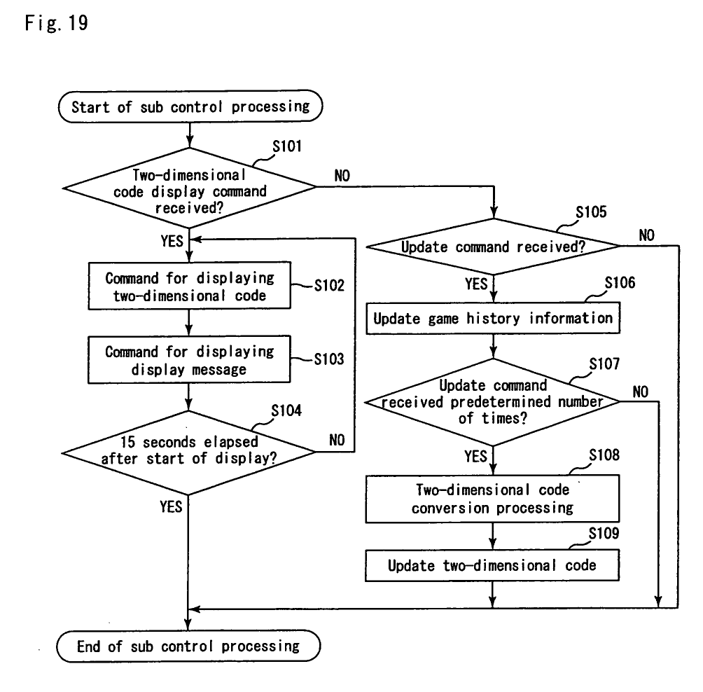

On the other hand, the sub control board 72 executes a sub control processing, according to various commands transmitted from the main control board 71. FIG. 17 is a flowchart (sub flowchart) illustrating operational procedures of the sub control processing repeatedly executed after start of the game in the pachi-slot machine 1. FIG. 17 and below-described FIG. 19 illustrate only steps relating to the present invention and do not illustrate other steps.

As illustrated in FIG. 17, the sub CPU 74 proceeds to step 101 after the sub control processing is started in the pachi-slot machine 1. The sub CPU 74 determines whether or not the sub CPU 74 has received the two-dimensional code display command transmitted from the main control board 71 in step 42. If the sub CPU 74 has received the command, it proceeds to step 102, and otherwise, it ends the sub control processing without executing the subsequent steps. In step 102, the sub CPU 74 operates as display control means according to the present invention and transmits a two-dimensional display command to the image control circuit 81 to display a two-dimensional code image G indicating a two-dimensional code on the liquid crystal display device 41 in a region corresponding to the two-dimensional code display portion 23a on the liquid crystal display device 41. On receiving the display command, the image control IC 88 in the image control circuit 81 reads out, from the image ROM 86, dot data required for display of the two-dimensional code image G and makes the two-dimensional code image G to be display. In subsequent step 103, the sub CPU 74 commands the image control circuit 81 to display a display massage at the massage display portion 23b. In step 104, it is determined whether or not a predetermined time (15 seconds in the present embodiment) has elapsed since the display massage was displayed. If it has not elapsed, the processing returns to step 102. If the predetermined time has elapsed, the sub control processing ends.

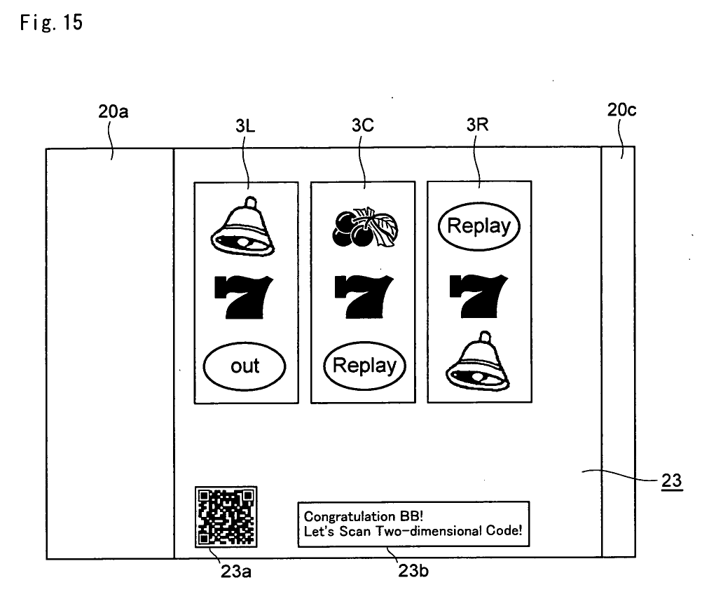

After the sub control processing is executed, as illustrated in FIG. 15, the liquid crystal display device 41 displays the two-dimensional code image G indicating a two-dimensional code at a region corresponding to the two-dimensional code display portion 23a and also displays a massage image indicating a display massage (for example, “Congratulation BB! Let's Scan Two-dimensional Code”) at the massage display portion 23b. Such a two-dimensional code is also referred to as a two-dimensional barcode and may be, for example, QR code (trademark of Denso Wave Corporation). The two-dimensional code includes a greater amount of information that is coded data, the greater amount of information being several tens times to several hundreds times that included in a barcode. In order to acquire the information included in the two-dimensional code, a predetermined reading device is required and, in recent years, mobile phones with readout means for two-dimensional codes have been employed. Therefore, when the player carries readout means such as a mobile phone equipped with readout means for two-dimensional codes, the player can read the two-dimensional code by holding the readout means over the two-dimensional code image G within the predetermined time (15 seconds) while the two-dimensional code image G is being displayed to acquire the great amount of information included in the two-dimensional code.

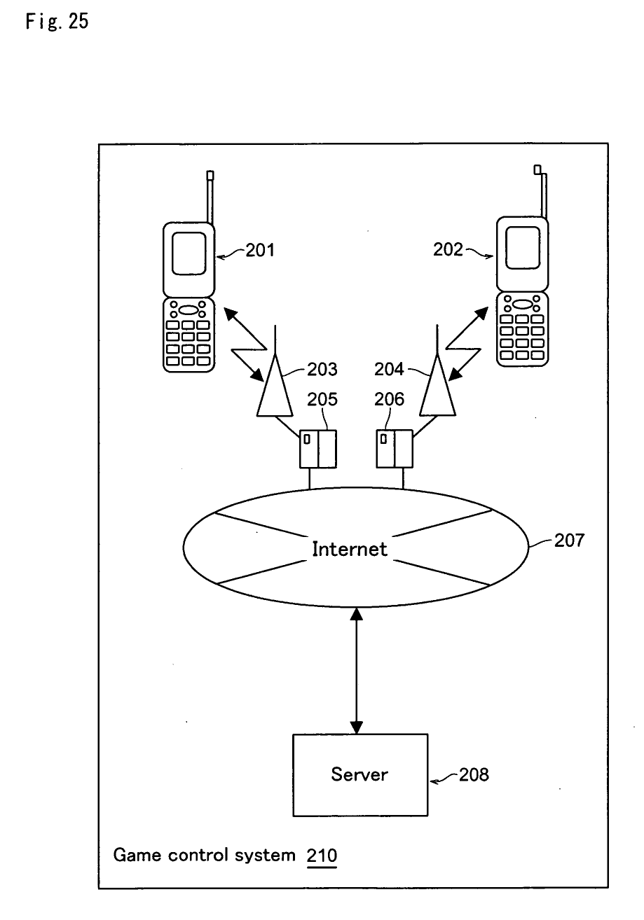

Then, for example, when the two-dimensional code includes information about an address of a predetermined WEB site, the player reads the two-dimensional code with a mobile phone to get the address, which enables the player to access the predetermined WEB site. In this case, for example, two mobile phones 201, 202 capable of communicating with each other can constitute a game control system 210, together with base stations 203, 204, exchanges 205, 206, and a server 208, as illustrated in FIG. 25. In the game control system 210, the mobile phones can be connected to the server 208 through the Internet 207 and can access the WEB site set in the server 208. This enables the player to acquire profitable information (for example, the machine model number of pachi-slot machine having a higher set probability out of pachi-slot machines installed in the game arcade or a value of the set probability) from the WEB site set in the server 208.

Thus, in the pachi-slot machine 1, if a predetermined condition is satisfied (if the winning combination is BB, in the present embodiment), the main control board 71 transmits a two-dimensional code display command to the sub control board 72. When the sub control board 72 receives the display command of the two-dimensional code command, a two-dimensional code image G is displayed on the liquid crystal display device 41, thereby providing profitable information to the player through the two-dimensional code. The two-dimensional code includes a greater amount of information than that included in a barcode, and therefore the display of the two-dimensional code can provide a profitable bonus to the player. Thereby, the pachi-slot machine 1 can provide, to the player, benefits of type different from the type of conventional benefits that is payout of coins, which allows for diversification of benefits to the player.

(Modified Example 1 of Main Control Processing and Sub Control Processing)

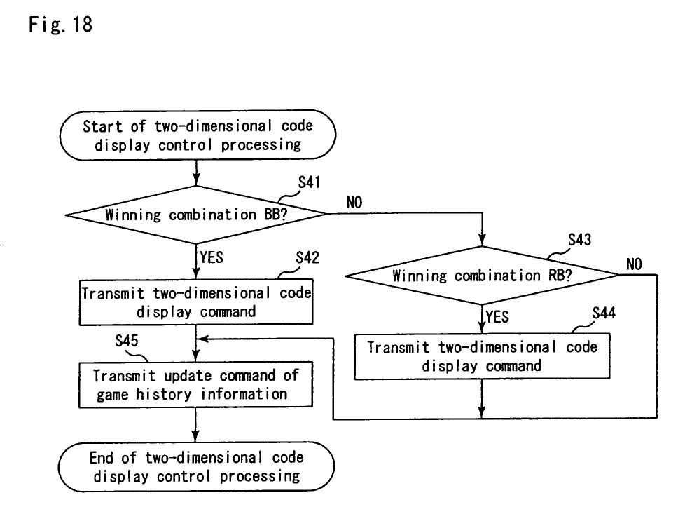

The pachi-slot machine 1 may execute the aforementioned two-dimensional code display control processing according to a flowchart illustrated in FIG. 18, in the main control processing and the sub control processing. According to the flowchart illustrated in FIG. 18, it is determined in step 41 whether or not the winning combination is BB as a first specific display condition. If the winning combination is BB, the processing proceeds to step 42 where a two-dimensional code display command is transmitted to the sub control board 72, and then the processing proceeds to step 45. If the winning combination is not BB, the processing proceeds to step 43 where it is determined whether or not the winning combination is RB as a second specific display condition. If the winning combination is RB, the processing proceeds to step 44 where a two-dimensional code display command is transmitted to the sub control board 72 and then the two-dimensional code display control processing ends. If the winning combination is not RB, the processing proceeds to step 45 without executing step 44. In step 45, an update command of game history information including the aforementioned game history information is transmitted to the sub control board 72 and thereafter the two-dimensional code display control processing ends. In the modified example 1, a two-dimensional code display command is transmitted in both the case where the winning combination is BB and the case where the winning combination is RB.

On the other hand, the sub control board 72 executes the sub control processing according to a flowchart illustrated in FIG. 19 when the main control board 71 executes the two-dimensional code display control processing in accordance with the flowchart illustrated in FIG. 18. The sub control processing illustrated in the flowchart in FIG. 19 is different from that in the flowchart in FIG. 17 in that steps 105 to 109 are executed if it is determined in step 101 that the two-dimensional code display command has not been received. The sub control processing illustrated in the flowchart in FIG. 19 is also different from that illustrated in the flowchart in FIG. 17 in that, in steps 102, 103, a command for displaying a two-dimensional code for display and a command for displaying a display massage corresponding to the two-dimensional code for display, which are mentioned below, are generated. Other steps are executed similarly to those illustrated in the flowchart in FIG. 17.

If the processing proceeds to step 105 because of no reception of the two-dimensional code display command, the sub CPU 74 determines whether or not the sub CPU 74 has received the update command of the game history information transmitted from the main control board 71 in step 45. If the sub CPU 74 has received the update command, the processing proceeds to step 106, and otherwise, the processing proceeds to step 110. In step 106, a processing for updating the game history information is executed. In this step, a processing for updating the game history information file stored in the work RAM 76 is executed using game history information included in the received update command of the game history information.

Next, in step 107, the sub CPU 74 operates as control means to determine whether or not the sub CPU 74 has received the update command of the game history information predetermined times (100 times, in the present embodiment), namely whether or not a game has been played the predetermined times. If the sub CPU 74 has received the update command the predetermine times, the processing proceeds to step 108 where a two-dimensional code conversion processing is executed. In the two-dimensional code conversion processing, the sub CPU 74 reads out the stored game history information from the game history information file in the work RAM 76 and inputs it to the image control CPU 82 through the IO ports 80, 85. The image control CPU 82 converts the read-out game history information into a two-dimensional code, according to code conversion programs stored in the image control program ROM 84. At this time, the sub CPU 74 operates as readout means according to the first aspect of the present invention and the image control CPU 82 operates as two-dimensional code conversion means according to the first aspect of the present invention.

Then, the processing proceeds to step 109. The two-dimensional code converted in step 108 is set as a two-dimensional code for display (a two-dimensional code set for updating the display content) and is stored in the video RAM 87. Thus, the two-dimensional code for display is updated and then the sub control processing ends.

As described above, if the processing described in the modified example 1 is executed, every time the update command has been received predetermined times, the game history information is updated, then the updated game history information is converted into a two-dimensional code and then the converted two-dimensional code is displayed on the liquid crystal display device 41. The game history information is updated every time a game has been played. Therefore, coded information included in the two-dimensional code can be successively updated in the pachi-slot machine 1 and a two-dimensional code image G indicating the updated two-dimensional code can be displayed. Accordingly, it is possible to display a two-dimensional code image G including content according to a progress of games in the pachi-slot machine 1, unlike cases of a two-dimensional code including fixed content. Therefore, the displayed two-dimensional code is more profitable for the player, and the pachi-slot machine 1 provides a more profitable benefit to the player.

(Modified Example 2 of Sub Control Processing)

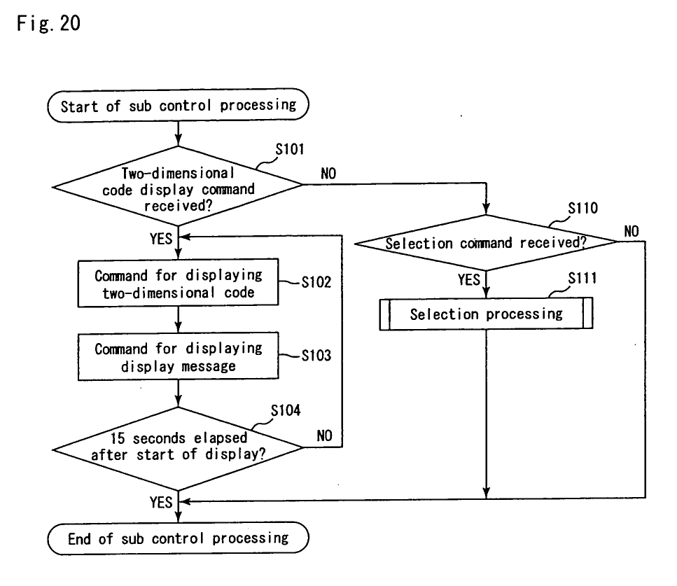

The pachi-slot machine 1 may execute the sub control processing according to a flowchart illustrated in FIG. 20 when the two-dimensional code display control processing in the main control processing is executed according to the flowchart illustrated in FIG. 17 or FIG. 18. The sub control processing illustrated in the flowchart in FIG. 20 is different from that illustrated in the flowchart in FIG. 17 in that steps 110, 111 are executed if it is determined in step 101 that the two-dimensional code display command has not been received. The sub control processing illustrated in the flowchart in FIG. 20 is also different from that illustrated in the flowchart in FIG. 17 in that, in steps 102, 103, a command for displaying a two-dimensional code for display and a command for displaying a display massage corresponding to the two-dimensional code for display are transmitted. Other steps are executed similarly to those in the flowcharts illustrated in FIG. 17.

If the processing proceeds to step 110 because of no reception of the two-dimensional code display command, it is determined whether or not the selection command transmitted in step 72 in the initial processing has been received. If the selection command has been received, the processing proceeds to step 111, and otherwise, the sub control processing ends.

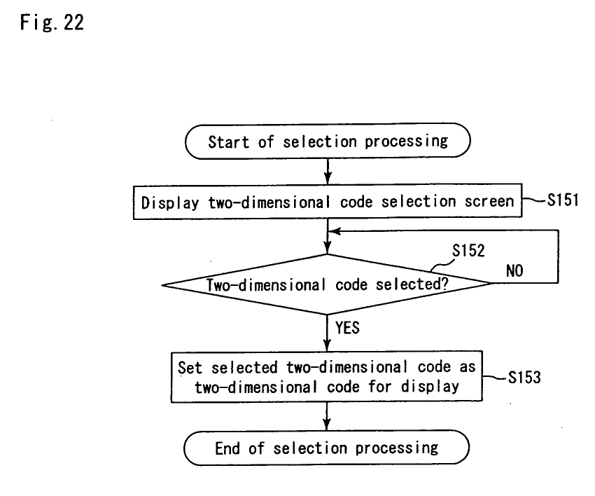

In step 111, a selection processing is executed according to a flowchart illustrated in FIG. 22. After starting the selection processing, the sub CPU 74 commands the image control circuit 81 to display a two-dimensional code selection image on the liquid crystal display device 41. The two-dimensional code selection image is displayed for making an operator such as a clerk of the game arcade in which the pachi-slot machine 1 is installed to select a two-dimensional code to be displayed on the liquid crystal display device 41 out of plural two-dimensional codes. The two-dimensional code selection image is formed to indicate a two-dimensional code and the (coded) information included in the two-dimensional code in association with each other such that the operator can select a desired two-dimensional code by operating the button unit 89. The image ROM 86 stores, as a group of two-dimensional codes, dot data of the plural two-dimensional codes which can be selected using the two-dimensional code selection image. In subsequent step 152, the sub CPU 74 waits for the selection of a two-dimensional code by the operator. If the operator selects a two-dimensional code, the processing proceeds to step 153, the selected two-dimensional code is set as a two-dimensional code for display and then is stored in the video RAM 87. Then, the selection processing ends and the sub control processing also ends.

As described above, the main control board 71 transmits a selection command to the sub control board 72 when the operator performs a predetermined operation at power-up. When the sub control board 72 receives the selection command, a screen for selection of a desired two-dimensional code from plural two-dimensional codes is displayed, which permits selection of a desired two-dimensional code. Accordingly, when the operator selects a desired two-dimensional code in consideration of various factors of the game arcade, a two-dimensional code image G indicating the selected two-dimensional code is displayed. Therefore, the two-dimensional code becomes more profitable for the player, and the pachi-slot machine 1 can provide more profitable benefits to the player.

(Modified Example 3 of Sub Control Processing)

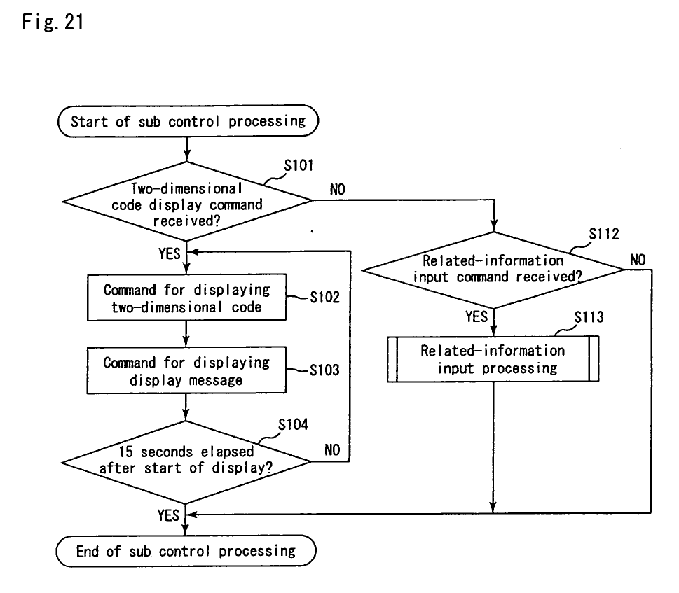

The pachi-slot machine 1 may execute the sub control processing according to a flowchart illustrated in FIG. 21, when the two-dimensional code display control processing in the main control processing is executed according to the flowchart illustrated in FIG. 17 or FIG. 18. The sub control processing illustrated in the flowchart in FIG. 21 is different from that illustrated in the flowchart in FIG. 17 in that steps 112, 113 are executed if it is determined in step 101 that the two-dimensional code display command has not been received. The sub control processing illustrated in the flowchart in FIG. 21 is also different from that illustrated in the flowchart in FIG. 17 in that, in steps 102, 103, a command for displaying a two-dimensional code for display and a command for displaying a display massage corresponding to the two-dimensional code for display are generated. Other steps are executed similarly to those in the flowchart illustrated in FIG. 17.

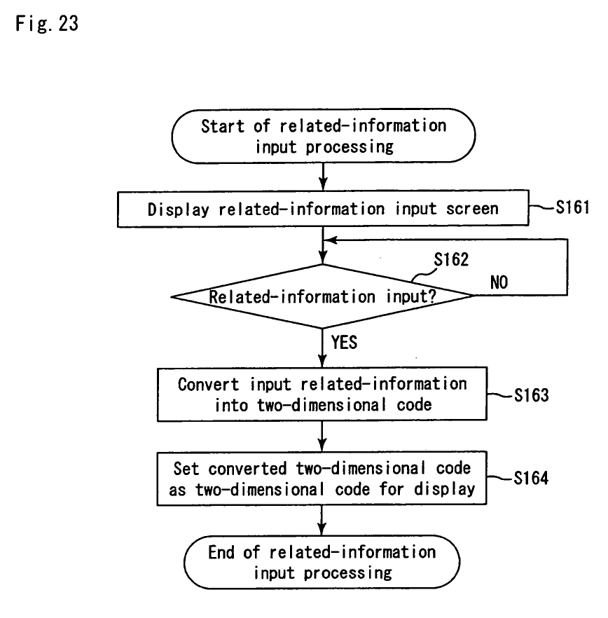

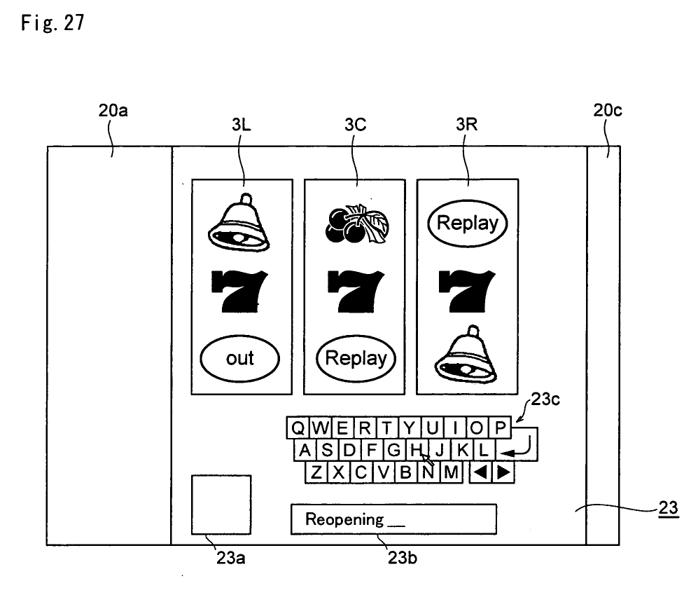

If the processing proceeds to step 112 because of no reception of the two-dimensional code display command, it is determined whether or not the related-information input command has been received. If the related-information input command has been received, the processing proceeds to step 113, and otherwise, the sub control processing ends. In step 113, a related-information input processing is executed according to a flowchart illustrated in FIG. 23. After start of the related-information input processing, the processing proceeds to step 161 where the sub CPU 74 commands the image control circuit 81 to display a related-information input image on the liquid crystal display device 41 (see FIG. 27). The related-information input image includes a keyboard image 23c displayed for enabling the operator to input information about the game arcade (such as information about the machine model number of a pachi-slot machine having a higher set probability on the current day and the next day, preferential admission on the next day, notification of reopening, such information will be referred to as “game arcade-related information” hereinafter) so that the operator can input game arcade-related information by operating the button unit 89.

When the operator has input game arcade-related information, the processing proceeds to step 163 where the sub CPU 74 operates as two-dimensional code conversion means and commands the image control CPU 82 in the image control circuit 81 to convert the input game arcade-related information into a two-dimensional code according to code conversion programs. At this time, the sub CPU 74 operates as two-dimensional code conversion means according to the third aspect of the present invention. Then, the processing proceeds to step 164, and the two-dimensional code converted in step 163 is set as a two-dimensional code for display and is stored in the video RAM 87 to update the two-dimensional code for display. Then, the related information input processing ends and the sub control processing also ends.

As described above, the operator performs operations different from those in the second modification at power-up, and thereby a screen for input of the game arcade-related information is displayed and then a two-dimensional code corresponding to the content input on the screen can be displayed. Also in this case, when the operator inputs information about the game arcade in consideration of various factors, a two-dimensional code image G indicating a two-dimensional code corresponding to the content is displayed. Therefore, also in this case, the two-dimensional code becomes made profitable for the player, and the pachi-slot machine 1 can provide more profitable benefits to the player. Namely, the operator flexibly changes the game arcade-related information on the basis of circumstances, which makes it possible to provide more profitable benefits to the player.

In the pachi-slot machine 1, an intervention processing (processing which is executed by temporarily intervening in the running program) is executed by intervening in the aforementioned main processing at predetermined intervals (for example, at 1.8773 ms intervals). Namely, when the main CPU 32 receives an intervention request signal from a timer or the like which is not shown, the main CPU 32 intervenes in the running program of the main processing and temporarily saves the running program to execute the program of the intervention processing. The intervention processing has been completed, and then the main CPU 32 restarts the execution of the saved program of the main processing at the point of the intervention.

(Operation Procedures of Intervention Processing)

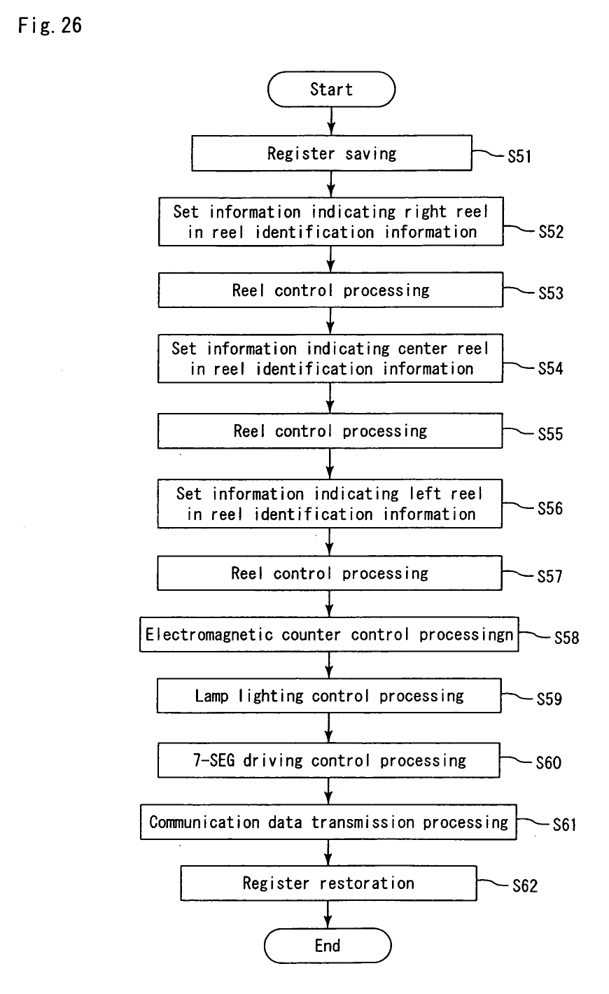

Hereinafter, the operation procedures of the intervention processing will be described with reference to a flowchart illustrated in FIG. 26. As illustrated in FIG. 26, in the pachi-slot machine 1, the running program in the main processing, which is stored in a storage region (resister) of a memory, is temporarily saved in step 51 after start of the intervention processing.

Then, in step 52, the main CPU 32 sets information about the reel 3R (the right reel) in reel identification information indicating information about the reels 3L, 3C or 3R stored in the RAM 33. Then, in step 53, a reel control processing is executed for the reel 3R. More specifically, the main CPU 32 commands the motor driving circuit 52 to output driving a signal to perform start of rotation, acceleration control, constant speed control, deceleration control and stop control for the reel 3R, and also the reel position detecting circuit 51 detects the position of the reel 3R (the positions of the symbols).

Then, in step 54, the main CPU 32 sets information about the reel 3C (the center reel) in reel identification information stored in the RAM 33. Then, in step 55, a reel control processing is executed for the reel 3C, similarly to the aforementioned case of the reel 3R.

Then, in step 56, the main CPU 32 sets information about the reel 3L (the left reel) in reel identification information stored in the RAM 33. Then, in step 57, a reel control processing is executed for the reel 3L, similarly to the aforementioned cases of the reels 3R, 3C.

Further, the processing proceeds to step 58 where an electromagnetic counter control processing is executed. The main CPU 32 controls a coin selector for sorting coins into legal coins and illegal coins, when coins are inserted.

Next, the processing proceeds to step 59 where a lamp lighting control processing is executed. The main CPU 32 lights a WIN lamp and the like, not shown, which are provided on the image display portion 20. The processing proceeds to subsequent step 60 where a 7-SEG driving control processing is executed. The main CPU 32 controls the display portion driving circuit 67 to display numerical values and the like on the payout display portion 18, the credit display portion 19 and the like, which is constituted by 7-segment (SEG) LEDs.

In step 61, the main CPU 32 executes a communication data transmission processing for transmitting various types of commands to the sub control board 72. Then, the processing proceeds to step 62, and the program of the main processing which was saved in step 51 is restored and restarted at the point of the intervention (save). Thus, the intervention processing ends.

In the aforementioned embodiments, the BB normal gaming state ends when 30 games have been completed or RB winning has been established three times. However, the present invention is not limited thereto. The BB normal gaming state may be ended when an arbitrary number of games have been completed or an arbitrary number of RB winnings have been established.

In the aforementioned embodiments, a pachi-slot machine has been described as an example. However, the present invention may be applied to gaming machines including image display means such as a liquid crystal display device, other than pachi-slot machines. For example, the present invention may be applied to: slot machines capable of displaying a reel image indicating reels including plural symbols, as a game image used during games, on image display means; card gaming machines capable of displaying a card image indicating cards on image display means; mah-jongg gaming machines for playing mah-jongg games; or pachinko machines including image display means. In these gaming machines, a CPU controls a progress of an image game using a game image, in accordance with programs stored in a ROM.

The specific display condition for making a determination whether or not a two-display code should be displayed is not limited to whether or not the BB or RB winning has been established. The determination may be made based on whether or not another gaming state has been generated.

What is claimed as new and desired to be secured by Letters Patent of the United States is:

1. A gaming machine comprising:
variable display means for variably displaying plural symbols in plural rows;
internal winning combination determination means for determining an internal winning combination for each game;
stop operation means which enables a player to perform a stop operation for stopping the variable display by said variable display means; and
image display means for displaying an image,
the gaming machine further comprising:
determination means for determining whether or not a specific display condition is satisfied, the specific display condition being for determining whether or not a two-dimensional code should be displayed on said image display means; and
display control means for displaying a two-dimensional code image indicating the two-dimensional code on said image display means if said determination means determines that said specific display condition is satisfied.

2. The gaming machine according to claim 1,
wherein
said determination means determines whether or not said specific display condition is satisfied on the basis of whether or not symbols of most profitable special increase combination are displayed on said variable display means.

3. A gaming machine displaying a game image used in a game on image display means for displaying said game image to control a progress of an image game using said game image,
the gaming machine further comprising:
determination means for determining whether or not a specific display condition is satisfied, the specific display condition being for determining whether or not a two-dimensional code should be displayed on said image display means; and
display control means for displaying a two-dimensional code image indicating the two-dimensional code on said image display means if said determination means determines that said specific display condition is satisfied.

4. A gaming machine comprising:
variable display means for variably displaying plural symbols in plural rows;
internal winning combination determination means for determining an internal winning combination for each game;
stop operation means which enables a player to perform a stop operation for stopping the variable display by said variable display means; and
image display means for displaying an image,
the gaming machine further comprising:
game history information storage means for storing game history information indicating a history of a game played by a player;
readout means for reading out said game history information stored in said game history information storage means;
two-dimensional code conversion means for converting said game history information read out by said readout means into a two-dimensional code; and
display control means for displaying a two-dimensional code image indicating said two-dimensional code converted by said two-dimensional code conversion means on said image display means.

5. The gaming machine according to claim 4, further comprising:
control means for controlling said two-dimensional code conversion means such that said two-dimensional code conversion means operates when a predetermined number of games have been played.

6. A gaming machine displaying a game image used in a game on image display means for displaying said game image to control a progress of an image game using said game image,
the gaming machine further comprising:
game history information storage means for storing game history information indicating the game history of games played by a player;
readout means for reading out said game history information stored in said game history information storage means;
two-dimensional code conversion means for converting said game history information read out by said readout means into a two-dimensional code; and
display control means for displaying a two-dimensional code image indicating said two-dimensional code converted by said two-dimensional code conversion means on said image display means.

7. The gaming machine according to claim 6, further comprising:
control means for controlling said two-dimensional code conversion means such that said two-dimensional code conversion means operates when a predetermined number of games have been played.

8. A gaming machine comprising:
variable display means for variably displaying plural symbols in plural rows;
internal winning combination determination means for determining an internal winning combination for each game;
stop operation means which enables a player to perform a stop operation for stopping the variable display by said variable display means; and
image display means for displaying an image,
the gaming machine further comprising:
input operation means for inputting game arcade-related information about a game arcade in which said gaming machine is installed;
two-dimensional code conversion means for converting said game arcade-related information which has been input through said input operation means into a two-dimensional code; and
display control means for displaying a two-dimensional code image indicating said two-dimensional code converted by said two-dimensional code conversion means on said image display means.

9. A gaming machine displaying a game image used in a game on image display means for displaying said game image to control a progress of an image game using said game image,
the gaming machine further comprising:
input operation means for inputting game arcade-related information about a game arcade in which said gaming machine is installed;
two-dimensional code conversion means for converting said game arcade-related information which has been input through said input operation means into a two-dimensional code; and
display control means for displaying a two-dimensional code image indicating said two-dimensional code converted by said two-dimensional code conversion means on said image display means.
